(19) United States
(12) Patent Application Publication
(10) Pub. No.: US 2011/0093818 A1
(43) Pub. Date: Apr. 21, 2011

(54) METHOD AND APPARATUS FOR PROVIDING A GENERIC INTERFACE CONTEXT MODEL

(75) Inventor: Sailesh Kumar Sathish, Tampere (FI)

(73) Assignee: Nokia Corporation

(21) Appl. No.: 12/603,188

(22) Filed: Oct. 21, 2009

(51) Int. Cl. G06F 3/048

(52) U.S. Cl. 715/853; 715/764

(57) ABSTRACT

An apparatus for providing a generic interface context model may include at least one processor and at least one memory including computer program code. The at least one memory and the computer program code may be configured to, with the at least one processor, cause the apparatus to perform at least defining a set of generic interfaces independent of any particular event scheme in which the generic interfaces include at least root node interfaces and provider node interfaces that support security classes, and enabling data providers and consumer applications to access a context model via the generic interfaces. The context model includes an object registry providing an object representation of properties of respective ones of the data providers.

### TECHNOLOGICAL FIELD

Embodiments of the present invention relate generally to communication interface technology and, more particularly, relate to a method and apparatus for providing a generic interface context model that, for example, may be used in providing context information to web applications.

### BACKGROUND

Delivery Context Client Interface (DCCI), which is a World Wide Web Consortium (W3C) specification, is a mechanism through which applications can access device data such as delivery context information using, for example, a Document Object Model (DOM)-like interface. As such, DCCI may act as a consumer interface for web applications (consumers) and providers of data to a tree-like interface. Context data, because of the inherent relationships that such data represents, may be represented in a tree structure. The tree structure represents a hierarchical relation between different context properties where each property may form a node in the tree, and DCCI is an example of such a structure. However, other topological structures in addition to the tree-like structure may also be employed for a consumer interface.

Although DCCI may be useful in providing information to applications about device status, DCCI may currently be considered limited by some due to its dependence on DOM. In this regard, current event models deployed by W3C especially for context models (e.g., DCCI) tend to be heavy in terms of processing (such as supporting all event phases for the same purpose) and are dependent on some DOM features that are not needed such as, for example, redundant event phases, support for document events, user interface (UI) events, mutations and others that are not suitable for context models. DCCI also fails to adequately address the mechanisms by which data is put into the model. Furthermore, DOM events may be too complex for usage in some situations and may lack desirable functionality.

Accordingly, it may be desirable to provide a framework for addressing at least some of the issues discussed above.

### BRIEF SUMMARY

A method, apparatus and computer program product are therefore provided for enabling the provision of a generic interface context model, for example, for use with web applications. Moreover, some embodiments of the present invention may include a context model that is relatively highly modularized and is not limited in its use of event schemes and representations. Accordingly, several deficiencies of earlier versions of the DCCI specification may be addressed.

In one example embodiment, a method of providing a generic interface for a context model is provided. The method may include defining a set of generic interfaces independent of any particular event scheme in which the generic interfaces include at least root node interfaces and provider node interfaces that support security classes, and enabling data providers and consumer applications to access a context model via the generic interfaces. The context model includes an object registry providing an object representation of properties of respective ones of the data providers. In some embodiments, property interfaces are also provided.

In another example embodiment, a computer program product for providing a generic interface for a context model is provided. The computer program product includes at least one computer-readable storage medium having computer-executable program code instructions stored therein. The computer-executable program code instructions may include program code instructions for defining a set of generic interfaces independent of any particular event scheme in which the generic interfaces include at least root node interfaces and provider node interfaces that support security classes, and enabling data providers and consumer applications to access a context model via the generic interfaces. The context model includes an object registry providing an object representation of properties of respective ones of the data providers. In some embodiments, property interfaces are also provided.

In another example embodiment, an apparatus for providing a generic interface context model is provided. The apparatus may include at least one processor and at least one memory including computer program code. The at least one memory and the computer program code may be configured to, with the at least one processor, cause the apparatus to perform at least defining a set of generic interfaces independent of any particular event scheme in which the generic interfaces include at least root node interfaces and provider node interfaces that support security classes, and enabling data providers and consumer applications to access a context model via the generic interfaces. The context model includes an object registry providing an object representation of properties of respective ones of the data providers. In some embodiments, property interfaces are also provided.

Embodiments of the invention may provide a method, apparatus and computer program product for employment in web based, or other network based operating environment. As a result, for example, device users may enjoy improved capabilities with respect to applications and services accessible via the device.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a schematic block diagram of a communication system according to an example embodiment of the present invention;

FIG. 2 is a schematic block diagram of an apparatus for providing a generic interface context model according to an example embodiment of the present invention;

FIG. 3 is block diagram illustrating the relationship between the context model, an application that may access information from the context model and various providers whose context information may be made available for consumers in accordance with an example embodiment of the present invention; and

FIG. 4 is a block diagram according to an example method for providing a generic interface context model according to an example embodiment of the present invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein a “computer-readable storage medium,” which refers to a physical storage medium (e.g., volatile or non-volatile memory device), can be differentiated from a “computer-readable transmission medium,” which refers to an electromagnetic signal.

Electronic devices have been rapidly developing in relation to their communication capabilities. As the capabilities of such devices have increased, applications that are sensitive to the capabilities of the devices have also been developed. Thus, for example, applications that are sensitive to the current operating state or context of devices have been developed. The devices are often able to determine, keep and communicate information about their own current operating state. For example, battery level, available bandwidth, certain device settings, hardware and software capabilities, local ambient light level and many other state related pieces of information may be determined and/or communicated to other devices. In order to communicate information on device operating state to various applications such as, for example, an application associated with accessing the web, an interface may be provided. An example of such an interface is Delivery Context Client Interface (DCCI), which is a World Wide Web Consortium (W3C) specification. DCCI may enable context information, which may be referred to as context information, to be made available to scripts running in web pages within a browser on a device.

Context is generally defined as any information that can be used to characterize the situation of an entity. Context parameters may include parameters related to, for example, environmental context, social context, spatio-temporal context, task context, personal context, terminal context, service context, access context, and/or the like. Context may be used to describe a set of characteristics of a device, a network, user preferences and other aspects that may apply to an interaction between the device and an application (e.g., a web application). Aspects of context could be either static or dynamic. Static aspects may include color resolution, display size, keyboard arrangement or other fixed properties of the device. Dynamic aspects may include properties of the device that may change over time such as current battery level, device orientation, device location, other applications running, and numerous other characteristics.

As indicated above, DCCI may be a mechanism through which applications can access context information using, for example, a DOM-like interface. Accordingly, applications can register event listeners on property nodes that initiate events based on property or other changes. In this regard, DCCI provides interfaces for applications that utilize context information. DCCI provides a tree-like representation of context data on a device that can be represented in a hierarchical manner conforming to some standard ontology; e.g., Delivery Context Ontology (DCO).

Because of inherent relationships that context information may represent, context information may be represented as a tree structure. The tree structure may represent a hierarchical relationship between different context properties in which each property may form a node in the tree structure. DCCI is one example of such a tree structure, but it should be understood that embodiments of the present invention extend beyond this one example and may be extended to many other data structures that specify relationships between data objects and/or how they can be effectively distributed and shared such as, for example, single backbone structures and mixed backbone-tree structures. A single backbone structure may be an example of a structure in which there is a single message bus and context nodes (e.g., providers) are connected directly to the message bus. In such a structure, traffic flows through the message bus and nodes listen to the bus. In a mixed backbone-tree structure, for example, there can be branches of the message bus directed away from a central bus. A mixed backbone-tree structure may be employed where there could be some level of hierarchy indications for a certain set of properties. With the backbone hierarchy, relations between properties may be contained within metadata and not through their connections. Meanwhile, with the mixed backbone-tree structure, relations may be mostly expressed through metadata, but there can also be connections amongst certain types of properties.

Context may be determined, for example, based on a determination of various context parameters. DCCI uses context information to enable adaptation that permits interaction with various applications while considering device context. In some cases, when devices are brought in proximity to each other in certain networks, such as smart spaces, context information, e.g. information regarding device capabilities, may desirably be shared between such devices so that each device can receive some information about the capabilities of the other device.

DOM events were meant for use in connection with document manipulation and are therefore not particularly suited for use in connection with context models. Accordingly, when current DCCI employs DOM events there may be unintended limits to functionality and inefficiencies introduced that would be desirable to mitigate or eliminate. Some examples of these inefficiencies were described above and also include an inability to support providers of context data and an inability to apply proper security codes in some cases.

Accordingly, embodiments of the present invention may provide for a generic interface context model that is not dependent on DOM interfaces or any particular event scheme, event propagation scheme, representation scheme or topology. Moreover, the generic interface context model of some embodiments of the present invention may support security classes, support both provider and consumer interfaces, and support adding abstractions. Thus, the generic interface context model described herein may provide for a lightweight solution that largely leaves optimization details to implementers so that, for example, competition may be fostered with respect to implementation based on event types and properties. Embodiments may also support such functions as an extension of standard interfaces by properties, class based extensions, local and remote properties, local storage, event firing by both consumers and providers, remote storage and synchronization of properties and data, and/or the like. These additional features that are provided beyond the capabilities of current DCCI are offered while still retaining some good aspects of DCCI such as uniform interfaces for properties, event based notifications and object based representations.

Thus, embodiments of the present invention may provide an application programming interface (API) having the associated features and data structures described above. The particular names assigned to the interfaces are not important as the namespace definition, certain structure definitions (e.g., a structure for generic value interface), metadata definitions and the like may be left to standardization bodies (e.g., W3C). Instead, embodiments of the present invention provide a generic interface context model that may be used, not only by browsers, but can also be used by other standalone applications on the device as an extension to the platform itself. The solution described herein does not rely on any particular web technologies, but will work well with, for example, JavaScript calls through JavaScript bindings that can be provided, for example, by W3C. Some example embodiments will now be described in the context of their operation within a typical communication environment.

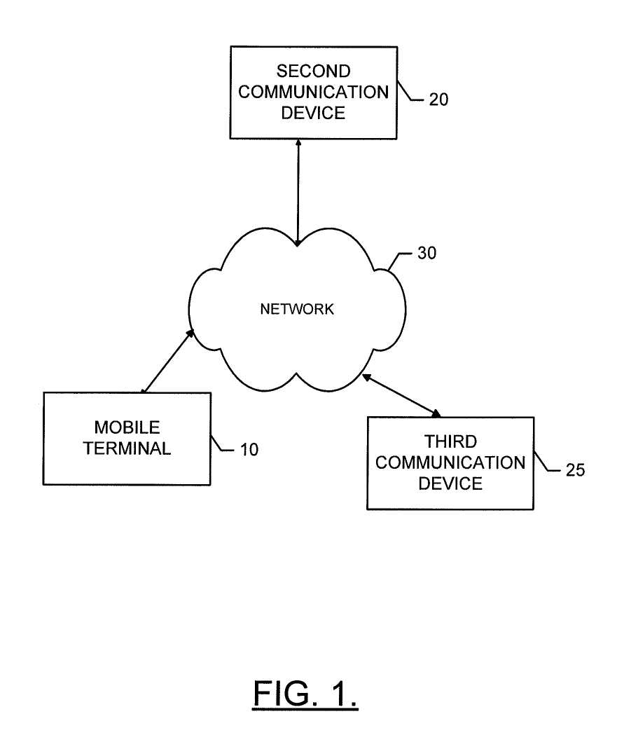

FIG. 1 illustrates a generic system diagram in which a device such as a mobile terminal 10 is shown in an example communication environment. As shown in FIG. 1, an embodiment of a system in accordance with an example embodiment of the present invention may include a first communication device (e.g., mobile terminal 10) and a second communication device 20 capable of communication with each other via a network 30. In some cases, embodiments of the present invention may further include one or more additional communication devices, one of which is depicted in FIG. 1 as a third communication device 25. In some embodiments, not all systems that employ embodiments of the present invention may comprise all the devices illustrated and/or described herein. While several embodiments of the mobile terminal 10 and/or second and third communication devices 20 and 25 may be illustrated and hereinafter described for purposes of example, other types of terminals, such as portable digital assistants (PDAs), pagers, mobile televisions, mobile telephones, gaming devices, laptop computers, cameras, video recorders, audio/video players, radios, global positioning system (GPS) devices, or any combination of the aforementioned, and other types of voice and text communications systems, can readily employ embodiments of the present invention. Furthermore, devices that are not mobile, such as servers and personal computers may also readily employ embodiments of the present invention.

The network 30 may include a collection of various different nodes (of which the second and third communication devices 20 and 25 may be examples), devices or functions that may be in communication with each other via corresponding wired and/or wireless interfaces. As such, the illustration of FIG. 1 should be understood to be an example of a broad view of certain elements of the system and not an all inclusive or detailed view of the system or the network 30. Although not necessary, in some embodiments, the network 30 may be capable of supporting communication in accordance with any one or more of a number of First-Generation (1G), Second-Generation (2G), 2.5G, Third-Generation (3G), 3.5G, 3.9G, Fourth-Generation (4G) mobile communication protocols, Long Term Evolution (LTE), and/or the like. In some embodiments, the network 30 may be a P2P network.

One or more communication terminals such as the mobile terminal 10 and the second and third communication devices 20 and 25 may be in communication with each other via the network 30 and each may include an antenna or antennas for transmitting signals to and for receiving signals from a base site, which could be, for example a base station that is a part of one or more cellular or mobile networks or an access point that may be coupled to a data network, such as a Local Area Network (LAN), a Metropolitan Area Network (MAN), and/or a Wide Area Network (WAN), such as the Internet. In turn, other devices such as processing elements (e.g., personal computers, server computers or the like) may be coupled to the mobile terminal 10 and the second and third communication devices 20 and 25 via the network 30. By directly or indirectly connecting the mobile terminal 10 and the second and third communication devices 20 and 25 (and/or other devices) to the network 30, the mobile terminal 10 and the second and third communication devices 20 and 25 may be enabled to communicate with the other devices or each other, for example, according to numerous communication protocols including Hypertext Transfer Protocol (HTTP) and/or the like, to thereby carry out various communication or other functions of the mobile terminal 10 and the second and third communication devices 20 and 25, respectively.

Furthermore, although not shown in FIG. 1, the mobile terminal 10 and the second and third communication devices 20 and 25 may communicate in accordance with, for example, radio frequency (RF), Bluetooth (BT), Infrared (IR) or any of a number of different wireline or wireless communication techniques, including LAN, Wireless LAN (WLAN), Worldwide Interoperability for Microwave Access (WiMAX), WiFi, Ultra-Wide Band (UWB), Wibree techniques and/or the like. As such, the mobile terminal 10 and the second and third communication devices 20 and 25 may be enabled to communicate with the network 30 and each other by any of numerous different access mechanisms. For example, mobile access mechanisms such as Wideband Code Division Multiple Access (W-CDMA), CDMA2000, Global System for Mobile communications (GSM), General Packet Radio Service (GPRS) and/or the like may be supported as well as wireless access mechanisms such as WLAN, WiMAX, and/or the like and fixed access mechanisms such as Digital Subscriber Line (DSL), cable modems, Ethernet and/or the like.

In an example embodiment, the network 30 may be an ad hoc or distributed network arranged to be a smart space. Thus, devices may enter and/or leave the network 30 and the devices of the network 30 may be capable of adjusting operations based on the entrance and/or exit of other devices to account for the addition or subtraction of respective devices or nodes and their corresponding capabilities. In an example embodiment, one or more of the devices in communication with the network 30 may employ a context model to assist in providing an interface between applications (e.g., web applications running on the mobile terminal 10 and acting as consumers) and providers (e.g., data providers in the form of network nodes such as the second and/or third communication devices 20 and 25). As such, for example, a consumer application may request information from a provider within the network 30 and any one of the mobile terminal 10 or the second and third communication devices 20 and 25 may host a consumer application while any other one of the mobile terminal 10 or the second and third communication devices 20 and 25 acts as a provider with respect to the consumer application to provide information such as context information to the respective consumer application. The context model may be an object based model in which each provider has an object representation in the model. Thus, the context model may provide consumer applications with access to context data that may include, for example, static and dynamic data descriptive of respective provider capabilities.

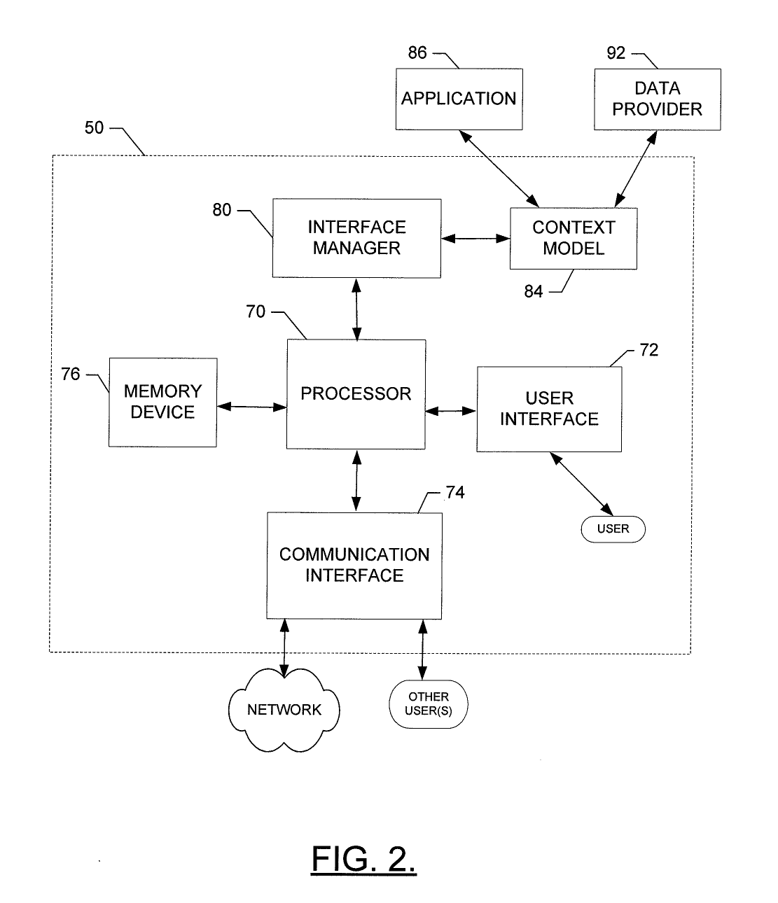

FIG. 2 illustrates a schematic block diagram of an apparatus for enabling the provision of a generic interface context model according to an example embodiment of the present invention. An example embodiment of the invention will now be described with reference to FIG. 2, in which certain elements of an apparatus 50 for providing a generic interface context model are displayed. The apparatus 50 of FIG. 2 may be employed, for example, on the mobile terminal 10 (and/or the second communication device 20 or the third communication device 25). Alternatively, the apparatus 50 may be embodied on a network device of the network 30. However, the apparatus 50 may alternatively be embodied at a variety of other devices, both mobile and fixed (such as, for example, any of the devices listed above). In some cases, embodiments may be employed on a combination of devices. Accordingly, some embodiments of the present invention may be embodied wholly at a single device (e.g., the mobile terminal 10), by a plurality of devices in a distributed fashion (e.g., on one or a plurality of devices in a P2P network) or by devices in a client/server relationship. Furthermore, it should be noted that the devices or elements described below may not be mandatory and thus some may be omitted in certain embodiments.

Referring now to FIG. 2, an apparatus 50 for providing a generic interface context model is provided. The apparatus 50 may include or otherwise be in communication with a processor 70, a user interface 72, a communication interface 74 and a memory device 76. The memory device 76 may include, for example, volatile and/or non-volatile memory. The memory device 76 may include, for example, one or more volatile and/or non-volatile memories. In other words, for example, the memory device 76 may be an electronic storage device (e.g., a computer readable storage medium) comprising gates configured to store data (e.g., bits) that may be retrievable by a machine (e.g., a computing device). The memory device 76 may be configured to store information, data, applications, instructions or the like for enabling the apparatus to carry out various functions in accordance with example embodiments of the present invention. For example, the memory device 76 could be configured to buffer input data for processing by the processor 70. Additionally or alternatively, the memory device 76 could be configured to store instructions for execution by the processor 70.

The processor 70 may be embodied in a number of different ways. For example, the processor 70 may be embodied as one or more of various processing means such as a coprocessor, a microprocessor, a controller, a digital signal processor (DSP), a processing element with or without an accompanying DSP, or various other processing devices including integrated circuits such as, for example, an ASIC (application specific integrated circuit), an FPGA (field programmable gate array), a microcontroller unit (MCU), a hardware accelerator, a special-purpose computer chip, processing circuitry, or the like. In an example embodiment, the processor 70 may be configured to execute instructions stored in the memory device 76 or otherwise accessible to the processor 70. Alternatively or additionally, the processor 70 may be configured to execute hard coded functionality. As such, whether configured by hardware or software methods, or by a combination thereof, the processor 70 may represent an entity (e.g., physically embodied in circuitry) capable of performing operations according to embodiments of the present invention while configured accordingly. Thus, for example, when the processor 70 is embodied as an ASIC, FPGA or the like, the processor 70 may be specifically configured hardware for conducting the operations described herein. Alternatively, as another example, when the processor 70 is embodied as an executor of software instructions, the instructions may specifically configure the processor 70 to perform the algorithms and/or operations described herein when the instructions are executed. However, in some cases, the processor 70 may be a processor of a specific device (e.g., a mobile terminal or network device) adapted for employing embodiments of the present invention by further configuration of the processor 70 by instructions for performing the algorithms and/or operations described herein. The processor 70 may include, among other things, a clock, an arithmetic logic unit (ALU) and logic gates configured to support operation of the processor 70.

Meanwhile, the communication interface 74 may be any means such as a device or circuitry embodied in either hardware, software, or a combination of hardware and software that is configured to receive and/or transmit data from/to a network and/or any other device or module in communication with the apparatus. In this regard, the communication interface 74 may include, for example, an antenna (or multiple antennas) and supporting hardware and/or software for enabling communications with a wireless communication network. In some environments, the communication interface 74 may alternatively or also support wired communication. As such, for example, the communication interface 74 may include a communication modem and/or other hardware/software for supporting communication via cable, digital subscriber line (DSL), universal serial bus (USB) or other mechanisms.

The user interface 72 may be in communication with the processor 70 to receive an indication of a user input at the user interface 72 and/or to provide an audible, visual, mechanical or other output to the user. As such, the user interface 72 may include, for example, a keyboard, a mouse, a joystick, a display, a touch screen, soft keys, a microphone, a speaker, or other input/output mechanisms. In an example embodiment in which the apparatus is embodied as a server or some other network devices, the user interface 72 may be limited, or eliminated. However, in an embodiment in which the apparatus is embodied as a communication device (e.g., the mobile terminal 10), the user interface 72 may include, among other devices or elements, any or all of a speaker, a microphone, a display, and a keyboard or the like. In this regard, for example, the processor 70 may comprise user interface circuitry configured to control at least some functions of one or more elements of the user interface, such as, for example, a speaker, ringer, microphone, display, and/or the like. The processor 70 and/or user interface circuitry comprising the processor 70 may be configured to control one or more functions of one or more elements of the user interface through computer program instructions (e.g., software and/or firmware) stored on a memory accessible to the processor 70 (e.g., memory device 76, and/or the like).

In an example embodiment, the processor 70 may be embodied as, include or otherwise control an interface manager 80. The interface manager 80 may be any means such as a device or circuitry operating in accordance with software or otherwise embodied in hardware or a combination of hardware and software (e.g., processor 70 operating under software control, the processor 70 embodied as an ASIC or FPGA specifically configured to perform the operations described herein, or a combination thereof) thereby configuring the device or circuitry to perform the corresponding functions of the interface manager 80 as described below. Thus, in examples in which software is employed, a device or circuitry (e.g., the processor 70 in one example) executing the software forms the structure associated with such means. In this regard, for example, the interface manager 80 may be configured to provide, among other things, for the provision of interfaces for both providers and consumers to a context model 84 that may be used to provide a model representation of objects so that information regarding context of the various objects may be provided to calling applications. Moreover, the interface manager 80 may define generic representations of properties to provide a generic context model so that, for example, web applications may be enabled to access context information to perform self adaptation and customization.

The context model 84 may support numerous types of topologies such as, for example, tree based hierarchical topologies, single backbone based topologies and/or mixed backbone-tree based topologies. The context model 84 may be a relatively highly modularized model of various properties associated with respective providers. Accordingly, consumers (e.g., applications including browser applications or web applications) may reference the context model 84 for context information regarding provider nodes in order to perform self adaptations and customizations. The context model 84 may be employed with any event scheme and any representation due to the generic interfaces provided by the interface manager 80. Moreover, in an example embodiment, no particular interface definition language (IDL) may be employed so that any suitable IDL may be supported.

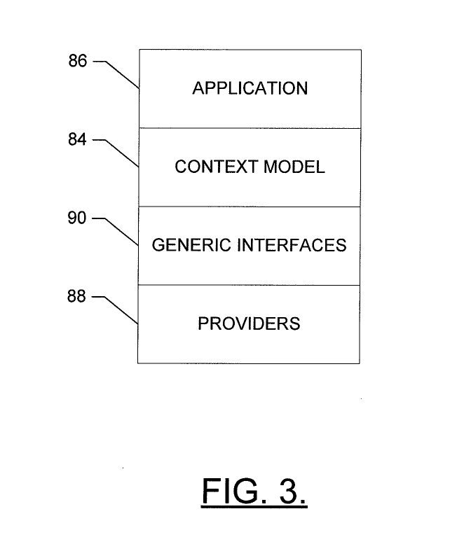

FIG. 3 illustrates the relationship between the context model 84, an application 86 that may access information from the context model 84 and various providers 88 whose context information may be made available for consumers (e.g., the application 86) to access. In this regard, as shown in FIG. 3, the providers 88 may add new properties to the context model 84 via generic interfaces 90. Moreover, the generic interfaces 90 may be defined by the interface manager 80 of an example embodiment.

In some embodiments, the interface manager 80 may therefore define generic interfaces that improve the flexibility of embodiments of the present invention with respect to providing a robust context model that may be free of many of the dependencies and limitations of prior context models associated with DCCI. As shown in FIG. 2, based on the generic interfaces defined by the interface manager 80, one or more applications (e.g., application 86) may act as consumers with respect to device context information provided to the context model 84 by data providers 92. Application 86 may be a web application or some other network application for which information about properties associated with the apparatus 50 of FIG. 2 may be useful. As such, in some cases, the application 86 may be in communication with the context model 84 via the communication interface 74 (and/or via the processor 70). In an example embodiment, the context model 84 may serve as a communication interface between data providers 92 and the application 86. The data provider 82 could be either a local provider or a remote provider (e.g., one of the second and third communication devices 20 and 25), which may act as a source of data. The data provider 92, like the application 86, may be in direct communication with the context model 84 (and/or the interface manager 80), or may establish such communication via the communication interface 74 or the processor 70.

In an example embodiment, the interface manager 80 may be embodied in a computer program product as instructions that are stored in the memory of a communication device (e.g., the mobile terminal 10 and/or the second and third communication devices 20 and 25) and executed by the processor 70. Alternatively, the interface manager 80 may be embodied as software that forms a part of or is installed on middleware, for example, of the communication device. As another alternative, the interface manager 80 may be embodied as the processor 70 (e.g., as an FPGA, ASIC, or the like). The interface manager 80 may be configured to develop interfaces for a context model (e.g., context model 84) including a model representation of multiple (in some cases all) devices in communication with the communication device (e.g., the mobile terminal 10 and/or the second and third communication devices 20 and 25). Accordingly, when, for example, a communication session is established between the mobile terminal 10 and the second communication device 20 and/or the third communication device 25, the context model 84 may provide a model representation of the second and/or third communication devices 20 and 25 with respect to the content and characteristics of each corresponding device based on information provided to the context model 84 via the generic interfaces 90 provided by the interface manager 80. As such, for example, if the second communication device 20 is a mobile telephone, the context model 84 may include capabilities and other characteristics of the mobile telephone. The context model 84 may include an object registry (e.g., object model) including an object representation of each corresponding object stored in the corresponding device. Accordingly, for each object created at the corresponding device, information about the characteristics, capabilities, data structure, manufacturer, version number, and other like information may be provided by the context model 84. In an example embodiment, when an application (e.g., application 86) uses or requests context data, a context value may be provided from the context model 84 based on the context information provided to the context model 84 via the interfaces provided by the interface manager 80.

```
Interface StringList{
    String Item(in unsigned long index);
    Readonly attribute unsigned long length;
}
```

Various characteristics of the interface manager 80 will now be described by way of example. In this regard, various nodes and interfaces defined by the interface manager 80 are identified and described below. In an example embodiment, the interface manager 80 may support various data types. In some cases, a StringList may provide the abstraction of an ordered collection of string values, without defining or constraining how the collection is implemented. As such, for example, the items in the StringList may be accessible via an integral index, starting from 0, similar to that which is described in the DOM3 Core specification as shown below.

Interface Node* contextInterface(string domain, optional string
signedCertificateParams);
, string interfaceType

The contextInterface may be a constructor interface that provides an interface to the context model 84 that is of the type indicated by interfaceType parameter. The interfaceType parameter can be either “root” or “provider” string. In the case of “root”, the method returns a RootNode interface and in the case of “provider”, it returns a providerNode interface. Thus the return type Node can either be a RootNode or providerNode.

### Root Node

In an example embodiment, the root node may be defined by the interface manager 80. The root node may include all information needed for an application to perform queries on the context model 84. In an example embodiment, the Root node may expose the following example interfaces:

```
Interface RootNode{
    Interface struct ModelInfo getModelData( );
    Interface String setModelData(string setParameter, stringList
    setValue);
    Interface fireEvent(struct eventStruct* event, optional PropertyNode);
    Interface propertyList* getPropertyList(in propertyFilterList* filter);
    Interface valueList* getLocalHistory(optional propertyFilterList*
    propertyList,
    optional propertyLocalStoreID, unsigned int milliseconds);
    Optional Interface requestSecurityMode(appCredential* credentials,
    string
    securityMode); and
    Optional Interface String synchronize(propertyList properties, String
    remoteURI, String SynchronizeMode, Optional String synchType).
}
```

A brief description of some of the above interface will now be provided by way of example.

In case of RootNode, each application may be enabled to create a new instance and the underlying model may provide the interface that is based on the security settings for that domain. The method returns the RootNode interface to the calling application. This interface can then be used to call all the root node interfaces. The contextInterface may be called as part of the document or window object of the browser and may be implementation specific. For example, an JavaScript application may get the RootNode interface by making the call rootNode=window.contextInterface(“application”, credentials, “root”);

//change this to some modelInfo structure that is returned
Interface struct ModelInfo getModelData( );

The interface getModelData is called to get information about the context model. Calling this method returns a ModelInfo structure that lists all the information about the current model.

Struct modelInfo{
String Version;
String OEM;
String EventScheme;
String ContextStructure;
String Ontology;
String Mode;
StringList SupportedEventSchemes;
StringList SupportedStructures;
}

The supported fields inside the ModelInfo structure may include Version (e.g., the current version number), OEM (e.g., the manufacturer name), NameSpace (e.g., the namespace to which the interface conforms), EventScheme (e.g., providing the current event scheme employed), ContextStructure (the current context structure e.g., providing the context representation structure employed such as “tree”, “backbone”, or “mixed”), Ontology (e.g., providing the current ontology supported by the implementation), Mode (e.g., local device context only or “smart” mode with tree composition), SupportedEventSchemes (e.g., providing a list of event schemes supported by the implementation), SupportedStructures (e.g., providing the list of context structures supported by the implementation). If more than one structure is supported, it may be possible for the application to request a particular structural representation of the model for the current session. The model can then re-organize the property nodes in accordance with that structure. This may also affect the particular event scheme employed.
Interface String setModeIData(string setParameter, stringList setValue);

The setParameter may indicate what property has to be set for this model and current session. The return value may indicate whether the setting has been a success, a failure, is not supported and is not authorized. The setValue may indicate the value that has to be set for this session. The setModelData is an optional interface that can return a not supported string for all parameters. Some examples of setParameters are provided below including:
EventScheme: set an event scheme that is different from default
ContextStructure: set a context structure that is different from default
Mode: change mode from local to smart or vice versa
Ontology: support a new ontology other than the default
Synchronize: synchronize properties with an external repository in which parameters to pass may include the uniform resource identifier (URI) of a remote repository, property list of properties to be synchronized
StorePropertyValue: store a particular property value that changed during the session. Return value is a string that is used as an identifier for later retrieval. In some cases, this value may only be possible in platforms where local storage is supported. Otherwise, not supported may be returned.
   Interface fireEvent(in struct eventStruct event, in optional PropertyNode);

The fireEvent interface is used by consumer properties to fire an event into the model for notification on properties. The event handler is also provided that must be called in case the parameters mentioned in eventStruct are statisfied. PropertyNode is optional. If propertyNode is present, then the corresponding property identified may be targeted. Otherwise, this flows either to the whole model or in a direction determined by a combination of context model structure and event scheme.

Interface propertyList* getPropertyList(in propertyFilterList filter);

The propertyList interface may be employed to obtain a list of properties within the model that satisfies filter criterion.

```
Interface propertyList{
        Property* Item(in unsigned long index);
    Readonly attribute unsigned long length;
}
Struct propertyFilterList{
        String propertyName;
        String propertyNameSpace;
        String propertyType; //denotes type of property example printer,
        defaultis “general”
        String valueType;
        String metadataType;
        String propertyProviderName;
        String propertyProviderNameSpace;
        String propertyProviderURI;
        String propertyInterfaceExtensionType;
        String propertyInterfaceExtensionURI;
        String propertyLocalStoreID;
        String propertyVersion;
        Enumerated String source; //Local or Remote property
        String sourceURI; //actual location of current property if remote
        String hierarchyLevel;
}
```

The propertyFilterList structure may provide a list of the filter criterion (all fields are optional) for one property. The filter may be used to determine whether a property is present in the context model. Since the context model does not assume exclusivity of this property, there can be multiple instances present and the propertyList may hold all instances of occurrence of this property.

Interface valueList* getLocalHistory(optional propertyFilterList
propertyList, optional StringList propertyLocalStoreID, unsigned
int milliseconds);

The valueList interface may enable retrieval of a local history of a property for the past N milliseconds from a local data store. The propertyLocalStoreID is an optional list of property local store id (if supported) that helps to identify particular properties. This is useful where they may be duplicates of properties within a storage service.

Optional Interface requestSecurityMode(appCredential* credentials, string
securityMode);

This interface requests the model that a particular security model may be granted for the calling application. The application submits its credentials and the requested security mode as parameters to the method call.

Optional Interface String synchronize(propertyList properties, String
remoteURI, String SynchronizeMode, Optional String synchType);

The String synchronize interface may be used to synchronize certain properties with a remote server, if supported. The SynchronizeMode parameter of this interface may denote how the synchronization happens (e.g., whether from local device only to server, from server to local device only or both ways (e.g., synchronization through timestamp conforming to (NTP) network time protocol)). The optional synchType parameter may provide a suggestion as to what protocol to employ for synchronization. In some cases, a default protocol may be provided, but others may be requested to override the default synchronization protocol.

In an example embodiment, the interface manager 80 may also define property node interfaces. Some examples of property node interfaces that may be defined are listed below. The property interface is obtained through the getPropertyList interface of RootNode. Following the list, a description of some aspects of the interfaces is provided.

Property Node Interfaces
Interface Property{
Interface valueList* getLocalHistory(optional date startDate, unsigned int
milliseconds);
Interface propertyInfo getPropertyInfo( );
Interface metadata getMetaData( );
Interface valueStruct getValue( );
Interface eventStruct* getAppEventList( );
Interface fireEvent(struct eventStruct* event);
Interface addEventHandler(struct eventStruct event, function
eventHandler);
Interface* queryInterface(string interfaceName);
Interface propertyList getDependants( );
}

A description of some aspects of these interfaces is now provided by way of example.

Interface valueList* getLocalHistory(optional date startDate, unsigned int
milliseconds);
Interface valueList{
Unsigned int length;
Optional unsigned int timeInterval;
Optional Date insertionDate;
valueStruct getValue(optional unsigned int long index, optional time);
}

The getLocalHistory method is used to get a time-based value list of property values over a period of time. This may be obtained either from the local storage module or obtained from a server-based storage depending on the implementation. The valueList interface may include an optional time interval provided to indicate the frequency with which the corresponding value has been updated to the local store. For some examples, the start of storing can be assumed to occur at zero time. The end time may be found by multiplying timeInterval by the length. The application (e.g., application 86) may be enabled to obtain the value either by using an index value or a time factor found by multiplying timeInterval with an index that is less than the length. The insertionDate parameter may provide the date the storage commenced.

Interface propertyInfo getPropertyInfo( )

The propertyInfo interface may be used to provide information structure corresponding to a particular property.

Struct propertyInfo{
String propertyName;
String propertyNameSpace;
String propertyType; //denotes type of property example printer, default
is “general”
String valueType;
String metadataType;
String propertyProviderName;
String propertyProviderNameSpace;
String propertyProviderURI;
String propertyInterfaceExtensionType;
String propertyInterfaceExtensionURI;
String propertyLocalStoreID;
String propertyVersion;
Unsigned int propertyUpdateTimeStamp;
Unsigned int propertyAddedTimeStamp;
Enumerated String source; //Local or Remote property
Optional String sourceURI; //actual location of current property if remote
}
Interface metadata getMetaData( );

The metadata interface may provide the metadata structure for the corresponding property. The fields in the structure may be property specific and may be defined in a separate document such as the ontology.

Interface valueStruct getValue( )

The method getValue returns the current value of the property. The valueStruct getValue interface may be NULL if no value is present.

Interface eventStruct* getAppEventList( );

The getAppEventList interface may enable access to a list of supported events that can be fired by a consumer of a corresponding property. This returns an eventStruct that lists the events supported by this property. All the properties support a basic set of events that may be defined by a separate authority. The events may be property change event, property addition event, property delete event, value change event etc. In addition, property specific events may also be supported that are listed through the eventStruct structure.

Interface fireEvent(in struct eventStruct event);

The fireEvent interface may be fired by a consumer application on a corresponding property. The fireEvent is used by the consumer to notify the property of any application state change or request some adapted or customized service dynamically.

Interface addEventHandler(struct eventStruct event, function eventHandler);

The interface addEventHandler is used by the consumer application to attach an event handler at that particular property to handle any particular or set of events. The event struct may be a super set of event parameters that may be used in filtering events, firing events from provider properties to consumer applications as well as requests for service from consumer applications to the model. The eventStruct may include multiples of eventName, eventType and optional eventPhase combinations.

Struct eventStruct{
String eventName;
String eventType; //defines the type of event, for example, topology
change event, value change event, node addition, node removal, etc.
Optional string eventPhase; //defines for what event phase the interface
is used (optional and dependent on the event scheme).
String list event parameters; //provides a list of parameters to be
determined.
}
Interface* queryInterface(string interfaceName);

The property can be queried for a particular interface, usually an extension to a standard interface. If supported, the interface (e.g., a function pointer) is returned. The calling application can then use the interface and its associated parameters.

Interface propertyList getDependants( )

The getDependants interface returns a list of properties that hold a first-level relation to this property. If a hierarchical relation exists between a property and other properties, the properties that fall in the immediate level below the current property is returned as a propertyList.

In an example embodiment, the interface manager 80 may also define provider node interfaces. The provider node interfaces may be used by providers of properties to provide an entry into the context model 84. By standardizing the provider node interfaces, new applications may be enabled to connect to the context model 84 and provide context data thereto. The provider node interfaces may be directly used by local applications to get entry to the context model 84 while remote applications can use a context model protocol wrapped up in appropriate transport packages to connect to the context model 84.

The manner by which the providers contact the context framework may, in some cases, be dependent on the platform and the implementation. For example, on a Linux based device, the D-Bus can be used for communicating to the framework. In other cases, a transport control protocol (TCP) connection may be used or, within the same address space, the provider can directly integrate a small provider extension directly calling the provider node interface while communicating separately with a provider micro-server. Thus, the same interface may be used by local or remote providers provided any context protocol supports the same functionalities as provided by the provider node interfaces. Some examples of provider node interfaces that may be defined are listed below with a corresponding description of some aspects of the respective interfaces.

Provider Node Interfaces
Optional providerNode* getProviderNodeInterface( );

This optional method returns the providerNode interface. The method can be called either as part of the window object or document object depending on the implementation type. Another way to get the providerNode interface is to call contextInterface method with “provider” parameter as explained earlier. Some examples of provider node interfaces are provided below.

Interface providerNode{
Interface String UniqueID getModelEntry(struct providerParameters,
String propertyType, propertyInfo property);
Interface String Status requestSecurityClass(provCredentials* credentials,
string securityClass, in string UniqueID);
Interface String registerExtensionCallBack(function* callback, in
string UniqueID);
Interface String Status setInterfaceExtensions(in struct extensionList
extension, in string UniqueID);
Interface String Status registerSupportedEvents(eventStruct events,
function* eventCallBack, Boolean acceptAll, in string UniqueID);
Interface updateValue(struct valueStruct, in string UniqueID);
Interface String status removeNode(in string UniqueID);
Interface unsigned int queryApplicationUsage(in string UniqueID);
}
Interface String UniqueID getModelEntry(struct providerParameters,
String propertyType, propertyInfo property);

The String UniqueID interface may sometimes be the first interface that is called. In this regard, the provider may submit its parameters to the framework and, if accepted, the framework may provide back a uniqueID for use during all future communications with the framework for a particular session. The PropertyType may define whether a property being added is considered to be a “direct” or “abstraction” node. Other propertyTypes may also be defined and added in the future. Direct nodes provide direct values from the provider whereas Abstract nodes (e.g., abstraction nodes) take values from other nodes based on some given formula.

The interfaces that immediately follow may be provided based on security considerations and based on whether the requested node is a direct or abstract node. In this regard, interfaces for direct node entry include:

Interface String Status requestSecurityClass(provCredentials* credentials,
string securityClass, in string UniqueID);

The interface above defines an interface used to request a particular security class for a corresponding provider.

Interface String registerExtensionCallBack(function* callback, in string UniqueID);

The method above defines an interface that may be called to register a function call-back that is called whenever an extension function to the property node is called. This is provided by the provider to the context model. The call-back may take in two parameters, the first of which may be the name of the application that called the function, and the second of which may be the string that denotes the function related string along with the parameter values. The manner by which the function name and parameters are interpreted may be up to the provider that provided the interface extension and the callback. After registering the callback, the provider may also call the SetInterfaceExtensions method to register the extension functions.

Interface String Status setInterfaceExtensions(in struct extensionList
extension, in string UniqueID);

The interface above defines an interface that may be used by providers to set extensions to the standard list of property interfaces. The in parameter may be an extensionList structure that lists the function name, the parameter that each function takes, and the string that is to be returned when a function call is made.

Struct extensionList{
String extensionType; //provides an extension type that defines this
extension, if any.
String extensionClass; //provides a security class to which this interface
belongs if supported by implementation.
Unsigned int length;
Struct ExtFunction function1;
Struct ExtFunction function2;
Struct ExtFunction function3;
......
};
Struct ExtFunction{
String extensionType; //provides an extension type to which this function
conforms if any.
If present, this takes //precedence over that of the extensionList struct.
String extensionClass; //provides a security class to which this interface
belongs if supported by implementation.
Unsigned int paramNos; //provides a number of parameters.
String name; //the extension function name
Type any parameter param1;
.....
String callBackString; //provides the callback string to use when calling
the registered callback. The callback string is concatenated with the string
versions of the parameter with each separated by an “&” sign and in order
of how they appear in the corresponding struct.
};
Interface String Status registerSupportedEvents(eventStruct events,
function* eventCallBack, Boolean acceptAll, in string UniqueID);

The interface above defines an interface that may be employed to register a set of events that are supported by the corresponding property. The events can be fired by the consumer to provide information regarding consumer status, needed configurations, setting parameters (either through extension or event firing), etc. The eventCallBack method is called by the framework with the eventstruct when the consumer fires the event to that propertynode. The acceptAll parameter shows whether to accept all events that come to the corresponding node or to accept only those that were fired on the corresponding node. Some example provider node interfaces for abstract nodes are listed below.

Interface providerNode{
Interface propertyList* queryProperty(in propertyList, in string UniqueID);
Interface valueStruct* getValue(in propertyList, in string UniqueID);
Interface updateValue(struct valueStruct, in string UniqueID);
Interface String status removeNode(in string UniqueID);
Interface unsigned int queryApplicationUsage(in string UniqueID);
}

The interfaces described immediately hereafter may only be provided if the node type is declared to be abstract node in some embodiments.

Interface propertyList* queryProperty(in propertyList, in string UniqueID);

The interface above defines an interface directing a query of the model for a list of properties that are supported and present. The return list provided responsive to this interface may have the list of properties that are present in the query within the model.

Interface valueStruct* getValue(in propertyList, in string UniqueID);

The interface above defines an interface that enables obtaining the value for properties mentioned in the property list.

The example interfaces that are described immediately hereafter may be common interfaces to both declarations (e.g., abstract and direct).

Interface updateValue(struct valueStruct, in string UniqueID);

The updateValue method may be used to update its current value to the model.

Interface String status removeNode(in string UniqueID);

The interface above defines an interface that may be used to remove the node from the model and close the session.

Interface unsigned int queryApplicationUsage(in string UniqueID);

The interface above defines an interface that may be used to query how many applications are using the provider property.

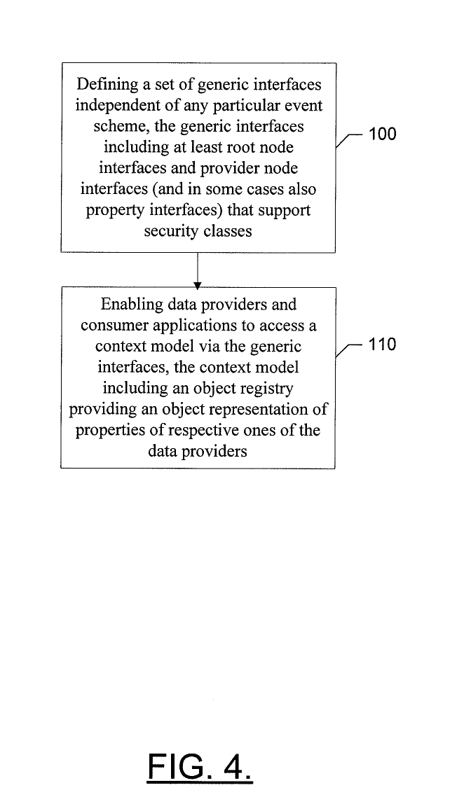

FIG. 4 is a flowchart of a method and program product according to example embodiments of the invention. It will be understood that each block or step of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory device of the mobile terminal or network device and executed by a processor in the mobile terminal or network device. As will be appreciated, any such computer program instructions may be loaded onto a computer or other programmable apparatus (e.g., hardware) to produce a machine, such that the instructions which execute on the computer or other programmable apparatus create means for implementing the functions specified in the flowchart block(s). These computer program instructions may also be stored in a computer-readable memory that may direct a computer or other programmable apparatus to function in a particular manner, such that the instructions stored in the computer-readable memory produce an article of manufacture including instruction means which implement the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks of the flowchart support combinations of means for performing the specified functions, combinations of operations for performing the specified functions and program instruction means for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In this regard, a method according to one embodiment of the invention, as shown in FIG. 4, may include defining (e.g., via a processor) a set of generic interfaces independent of any particular event scheme in which the generic interfaces include at least root node interfaces and provider node interfaces that support security classes at operation 100. The method may further include enabling data providers and consumer applications to access a context model via the generic interfaces at operation 110. The context model may include an object registry providing an object representation of properties of respective ones of the data providers.

In some embodiments, certain ones of the operations above may be modified or further amplified as described below. It should be appreciated that each of the modifications or amplifications below may be included with the operations above either alone or in combination with any others among the features described herein. In this regard, for example, enabling access to the context model may include enabling access via a topologically independent delivery context client interface context model associated with any one of a tree based topology, a single backbone based topology or a mixed backbone-tree based topology. In some embodiments, defining the set of generic interfaces may include defining the set of generic interfaces to support addition of abstract nodes and direct nodes. Alternatively or additionally, defining the set of generic interfaces may include defining the set of generic interfaces to include property node interfaces. In some cases, defining the set of generic interfaces may include defining the set of generic interfaces to enable data providers and consumers to fire events, to enable remote storage of properties, and/or to enable synchronization of properties.

In an example embodiment, an apparatus for performing the method of FIG. 3 above may comprise a processor (e.g., the processor 70) configured to perform some or each of the operations (100-110) described above. The processor may, for example, be configured to perform the operations (100-110) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 100-110 may comprise, for example, the processor 70, the interface manager 80, and/or a device or circuit for executing instructions or executing an algorithm for processing information as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. An apparatus comprising at least one processor and at least one memory including computer program code, the at least one memory and the computer program code configured to, with the at least one processor, cause the apparatus at least to perform:
defining a set of generic interfaces independent of any particular event scheme, the generic interfaces including at least root node interfaces and provider node interfaces that support security classes; and
enabling data providers and consumer applications to access a context model via the generic interfaces, the context model including an object registry providing an object representation of properties of respective ones of the data providers.

2. The apparatus of claim 1, wherein the at least one memory and the computer program code are further configured to, with the at least one processor, cause the apparatus to provide the context model for use within a topologically independent delivery context client interface context model associated with any one of a tree based topology, a single backbone based topology or a mixed backbone-tree based topology.

3. The apparatus of claim 1, wherein the at least one memory and the computer program code are further configured to, with the at least one processor, cause the apparatus to support addition of abstract nodes and direct nodes.

4. The apparatus of claim 1, wherein the at least one memory and the computer program code are further configured to, with the at least one processor, cause the apparatus to define the generic interfaces to include property node interfaces.

5. The apparatus of claim 1, wherein the at least one memory and the computer program code are further configured to, with the at least one processor, cause the apparatus to enable data providers and consumers to fire events.

6. The apparatus of claim 1, wherein the at least one memory and the computer program code are further configured to, with the at least one processor, cause the apparatus to enable remote storage of properties.

7. The apparatus of claim 1, wherein the at least one memory and the computer program code are further configured to, with the at least one processor, cause the apparatus to enable synchronization of properties.

8. A method comprising:
defining, via a processor, a set of generic interfaces independent of any particular event scheme, the generic interfaces including at least root node interfaces and provider node interfaces that support security classes; and
enabling data providers and consumer applications to access a context model via the generic interfaces, the context model including an object registry providing an object representation of properties of respective ones of the data providers.

9. The method of claim 8, wherein enabling access to the context model comprises enabling access via a topologically independent delivery context client interface context model associated with any one of a tree based topology, a single backbone based topology or a mixed backbone-tree based topology.

10. The method of claim 8, wherein defining the set of generic interfaces further comprises defining the set of generic interfaces to support addition of abstract nodes and direct nodes.

11. The method of claim 8, wherein defining the set of generic interfaces further comprises defining the set of generic interfaces to include property node interfaces.

12. The method of claim 8, wherein defining the set of generic interfaces further comprises defining the set of generic interfaces to enable data providers and consumers to fire events.

13. The method of claim 8, wherein defining the set of generic interfaces further comprises defining the set of generic interfaces to enable remote storage of properties.

14. The method of claim 8, wherein defining the set of generic interfaces further comprises defining the set of generic interfaces to enable synchronization of properties.

15. A computer program product comprising at least one computer-readable storage medium having computer-executable program code instructions stored therein, the computer-executable program code instructions comprising:
program code instructions for defining a set of generic interfaces independent of any particular event scheme, the generic interfaces including at least root node interfaces and provider node interfaces that support security classes; and
program code instructions for enabling data providers and consumer applications to access a context model via the generic interfaces, the context model including an object registry providing an object representation of properties of respective ones of the data providers.

16. The computer program product of claim 15, wherein program code instructions for enabling access to the context model include instructions for enabling access via a topologically independent delivery context client interface context model associated with any one of a tree based topology, a single backbone based topology or a mixed backbone-tree based topology.

17. The computer program product of claim 15, wherein program code instructions for defining the set of generic interfaces further include instructions for defining the set of generic interfaces to support addition of abstract nodes and direct nodes.

18. The computer program product of claim 15, wherein program code instructions for defining the set of generic interfaces further include instructions for defining the set of generic interfaces to include property node interfaces.

19. The computer program product of claim 15, wherein program code instructions for defining the set of generic interfaces further include instructions for defining the set of generic interfaces to enable data providers and consumers to fire events.

20. The computer program product of claim 15, wherein program code instructions for defining the set of generic interfaces further include instructions for defining the set of generic interfaces to enable remote storage of properties and synchronization of properties.
